(19) United States
(12) Patent Application Publication
(10) Pub. No.: US 2025/0104309 A1
(43) Pub. Date: Mar. 27, 2025

(54) SEMANTIC-BASED IMAGE EDITING METHOD AND SYSTEM, AND MEDIUM

(71) Applicant: Shuhui Qu, Beijing (CN)

(72) Inventor: Shuhui Qu, Beijing (CN)

(21) Appl. No.: 18/789,482

(22) Filed: Jul. 30, 2024

(30) Foreign Application Priority Data
Sep. 27, 2023 (CN) 202311266715.7

(51) Int. Cl. G06T 11/60; G06F 40/30; G06V 10/771

(52) U.S. Cl. CPC G06T 11/60; G06F 40/30; G06V 10/771

(57) ABSTRACT

The present disclosure discloses a semantic-based image editing method and system, and a medium, relating to the field of image processing. The method includes: obtaining text on which image editing is based and parsing semantic information in the text, where the semantic information in the text is used to describe an image editing operation and image content corresponding to the operation; performing the image editing operation based on the semantic information in the text, where the image editing operation includes at least one of an operation of generating a new image, an operation of adding content to a to-be-edited image, an operation of modifying content of the to-be-edited image, and an operation of deleting content from the to-be-edited image; and refining an edited image to obtain a refined image.

### CROSS REFERENCE TO RELATED APPLICATION

This patent application claims the benefit and priority of Chinese Patent Application No. 202311266715.7, filed with the China National Intellectual Property Administration on Sep. 27, 2023, the disclosure of which is incorporated by reference herein in its entirety as part of the present application.

### TECHNICAL FIELD

The present disclosure relates to the field of image processing, and in particular, to a semantic-based image editing method and system, and a medium.

### BACKGROUND

In recent years, with the emergence of advanced models such as DALL E, Midjourney, and Enhanced Representation through Knowledge Integration (ERNIE) Bot, significant development has been achieved in text-based image generation. These models can generate diverse and high-quality visual content based on a text input. However, text-based image editing does not provide a capability for adjusting or generating a region of interest in an image. Usually, manual efforts are required in text-based image editing, for example, to modify the region of interest. An existing text-based image generation tool is insufficient in accurately understanding information related to an object quantity and location.

### SUMMARY

The present disclosure aims to provide a semantic-based image editing method and system, and a medium. Semantic information in input text is parsed to guide operations such as image generation, modification, deletion, and addition, to ensure consistency and coherence between an edited image and the semantic information in the text.

To achieve the above objective, the present disclosure provides the following technical solutions.

A semantic-based image editing method is provided, where the method includes:
obtaining text on which image editing is based and parsing semantic information in the text, where the semantic information in the text is used to describe an image editing operation and image content corresponding to the operation;
performing the image editing operation based on the semantic information in the text, where the image editing operation includes at least one of an operation of generating a new image, an operation of adding content to a to-be-edited image, an operation of modifying content of the to-be-edited image, and an operation of deleting content from the to-be-edited image; and
refining an edited image to obtain a refined image.

Optionally, when the image editing operation is the operation of generating a new image, the performing the image editing operation based on the semantic information in the text specifically includes:
determining entities and entity attributes in the text based on the semantic information in the text, and determining a relationship network between entities based on the entities and the entity attributes in the text, where the entities include target objects in an image and an image background;
generating an entity mask map corresponding to each entity based on the relationship network between entities, where the entity mask map is used to define an image region in which the entity is placed;
performing entity type embedding on the entity mask map for each entity to obtain each entity type embedding mask map;
generating a text embedding map for each entity based on a textual description of an entity attribute in the text, and obtaining each entity embedding feature map based on each entity type embedding mask map and a corresponding text embedding map; and
inputting each entity embedding feature map into an image generation model to obtain the edited image.

Optionally, the inputting each entity embedding feature map into an image generation model to obtain the edited image specifically includes:
randomly numbering the target objects;
inputting an entity embedding feature map corresponding to a first target object and a blank image into the image generation model to obtain an image including one target object;
inputting an image including first i target objects and an entity embedding feature map corresponding to an (i+1)^{th} target object into the image generation model to obtain an image including (i+1) target objects, where i=1, 2, 3, . . . , and M, and M represents a quantity of target objects;
letting i=i+1, and repeating the step “inputting an image including first i target objects and an entity embedding feature map corresponding to an (i+1)^{th} target object into the image generation model”, until an image including M target objects is obtained; and
inputting the image including M target objects and an entity embedding feature map corresponding to the image background into the image generation model to generate the edited image, where content in the edited image is consistent with the semantic information in the text.

Optionally, when the image editing operation is the operation of adding content to a to-be-edited image, the performing the image editing operation based on the semantic information in the text specifically includes:
identifying original entities and original entity attributes in the to-be-edited image, and generating original entity mask maps for all the original entities;
selecting a reference entity mask map from the original entity mask maps based on the semantic information in the text, where the reference entity mask map is a mask map corresponding to an original entity mentioned in the semantic information in the text;
determining a new entity mask map corresponding to a new entity based on the reference entity mask map;
performing entity type embedding on the new entity mask map to obtain a new entity type embedding mask map;
generating a text embedding map for the new entity based on a textual description of a new entity attribute in the text, and obtaining an embedding feature map for the new entity based on the new entity type embedding mask map and the corresponding text embedding map;
inputting the to-be-edited image and the embedding feature map for the new entity into an image generation model to obtain a new entity image, where the new entity image incorporates image information of the to-be-edited image; and
inputting the new entity image and the to-be-edited image into the image generation model to obtain the edited image, where the edited image is an image obtained after the new entity image is added to the to-be-edited image.

Optionally, when the image editing operation is the operation of modifying content of the to-be-edited image, the performing the image editing operation based on the semantic information in the text specifically includes:
identifying original entities and original entity attributes in the to-be-edited image, and generating original entity mask maps for all the original entities;
selecting a to-be-modified entity mask map from the original entity mask maps based on the semantic information in the text, and modifying the to-be-modified entity mask map to a modified entity mask map based on a textual description of a modified entity attribute in the text, where the semantic information in the text records an original entity that is to be modified and provides an information description of a modified entity;
obtaining an embedding feature map for the modified entity based on the textual description of the modified entity attribute and the modified entity mask map; and
inputting the embedding feature map for the modified entity and the to-be-edited image into an image generation model to obtain the edited image, where the edited image is an image generated after a modification operation is performed.

Optionally, when the image editing operation is the operation of deleting content from the to-be-edited image, the performing the image editing operation based on the semantic information in the text specifically includes:
identifying original entities and original entity attributes in the to-be-edited image, and generating original entity mask maps for all the original entities;
selecting a to-be-deleted entity mask map from the original entity mask maps based on the semantic information in the text, where the semantic information in the text records an original entity that is to be deleted;
combining all the original entity mask maps except the to-be-deleted entity mask map, and generating an embedding feature map for a combined entity based on a combined mask map; and
inputting the embedding feature map for the combined entity and the to-be-edited image into an image generation model to obtain the edited image, where the edited image is an image obtained after a deletion operation is performed.

Optionally, the obtaining text on which image editing is based and parsing semantic information in the text specifically includes:
obtaining the text on which image editing is based and parsing the text by using a natural language processing (NLP) technology, to obtain the semantic information in the text.

Optionally, the refining an edited image to obtain a refined image specifically includes:
inputting the edited image into an image optimization model to obtain the refined image, where the image optimization model uses a diffusion model as a backbone network.

The present disclosure further provides a semantic-based image editing system, where the system includes:
a text semantic obtaining module, configured to: obtain text on which image editing is based and parse semantic information in the text, where the semantic information in the text is used to describe an image editing operation and image content corresponding to the operation;
an image editing operation module, configured to perform the image editing operation based on the semantic information in the text, where the image editing operation includes at least one of an operation of generating a new image, an operation of adding content to a to-be-edited image, an operation of modifying content of the to-be-edited image, and an operation of deleting content from the to-be-edited image; and
an image refining module, configured to refine an edited image to obtain a refined image.

The present disclosure further provides a computer-readable storage medium storing a computer program. When the computer program is executed by a processor, the semantic-based image editing method is implemented.

According to specific embodiments provided in the present disclosure, the present disclosure has the following technical effects:

The present disclosure provides a semantic-based image editing method and system, and a medium. The method includes: obtaining text on which image editing is based and parsing semantic information in the text, where the semantic information in the text is used to describe an image editing operation and image content corresponding to the operation; performing the image editing operation based on the semantic information in the text, where the image editing operation includes at least one of an operation of generating a new image, an operation of adding content to a to-be-edited image, an operation of modifying content of the to-be-edited image, and an operation of deleting content from the to-be-edited image; and refining an edited image to obtain a refined image. Semantic information in input text is parsed to guide operations such as image generation, modification, deletion, and addition, to ensure consistency and coherence between an edited image and the semantic information in the text.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a flowchart of a semantic-based image editing method according to Embodiment 1 of the present disclosure;

FIG. 2 is a conceptual diagram of a semantic-based image editing method according to Embodiment 1 of the present disclosure;

FIG. 3 is a flowchart for performing a generation operation according to Embodiment 1 of the present disclosure;

FIG. 4 is a flowchart for generating an entity embedding feature map according to Embodiment 1 of the present disclosure;

FIG. 5 is a schematic diagram of an image result obtained after a generation operation is performed according to Embodiment 1 of the present disclosure;

FIGS. 6A-6B are schematic diagrams of entity mask maps according to Embodiment 1 of the present disclosure;

FIG. 7 is a flowchart for performing an addition operation according to Embodiment 1 of the present disclosure;

FIG. 8 is a flowchart for generating entity mask maps based on an input image according to Embodiment 1 of the present disclosure;

FIG. 9 is a schematic diagram of an image result obtained after an addition operation is performed according to Embodiment 1 of the present disclosure;

FIG. 10 is a flowchart for performing a modification operation according to Embodiment 1 of the present disclosure;

FIGS. 11A-11B are schematic diagrams of an image result obtained after a modification operation is performed according to Embodiment 1 of the present disclosure;

FIG. 12 is a flowchart for performing a deletion operation according to Embodiment 1 of the present disclosure;

FIG. 13 is a schematic diagram of determining a to-be-deleted object according to Embodiment 1 of the present disclosure;

FIGS. 14A-14B are schematic diagrams of an image result obtained after a deletion operation is performed according to Embodiment 1 of the present disclosure; and

FIG. 15 is a framework diagram of a semantic-based image editing system according to Embodiment 2 of the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely some rather than all of the embodiments of the present disclosure. All other embodiments obtained by those skilled in the art based on the embodiments of the present disclosure without creative efforts shall fall within the protection scope of the present disclosure.

The present disclosure aims to provide a semantic-based image editing method and system, and a medium. Semantic information in input text is parsed to guide operations such as image generation, modification, deletion, and addition, to ensure consistency and coherence between an edited image and the semantic information in the text.

In order to make the above objective, features and advantages of the present disclosure clearer and more comprehensible, the present disclosure will be further described in detail below in combination with accompanying drawings and particular implementation modes.

### Embodiment 1

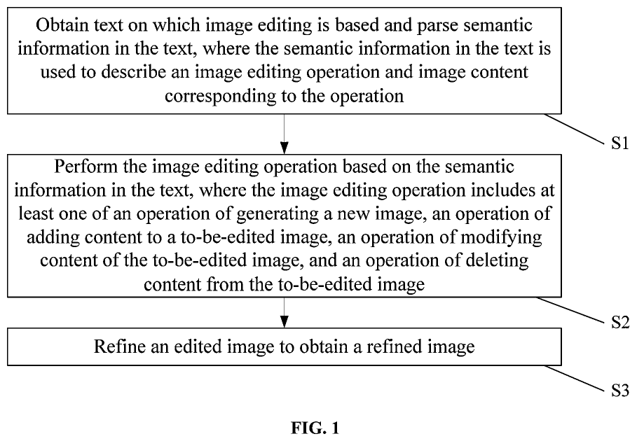

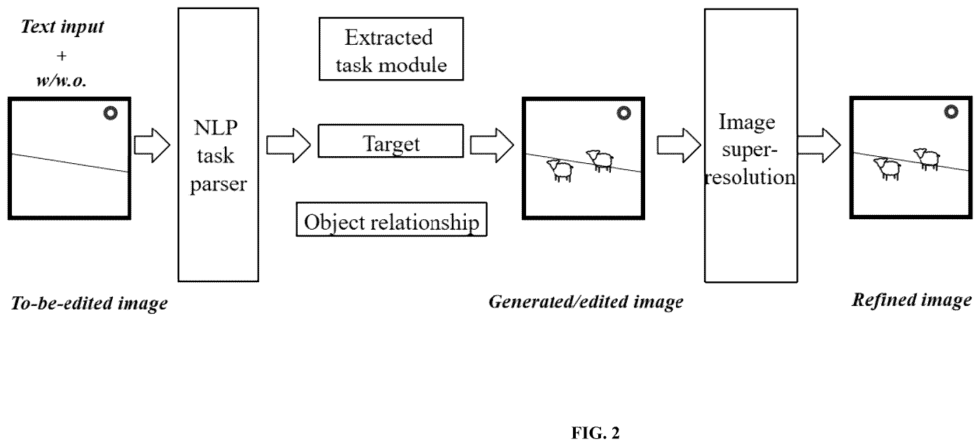

As shown in FIG. 1 and FIG. 2, this embodiment provides a semantic-based image editing method. The method includes the following steps:

S1: Obtain text on which image editing is based and parse semantic information in the text. The semantic information in the text is used to describe an image editing operation and image content corresponding to the operation.

An NLP technology is used to parse the text, to obtain the semantic information in the text.

S2: Perform the image editing operation based on the semantic information in the text. The image editing operation includes at least one of an operation of generating a new image, an operation of adding content to a to-be-edited image, an operation of modifying content of the to-be-edited image, and an operation of deleting content from the to-be-edited image. An extracted task module in FIG. 2 is configured to determine the foregoing image editing operation to be performed. A target in FIG. 2 indicates a to-be-edited target, that is, a to-be-generated object, a to-be-added object, a to-be-modified object, or a to-be-deleted object. Image super-resolution in FIG. 2 indicates an image refining operation.

Specifically, a corresponding image is generated based on a semantic meaning in input text. Alternatively, if the input text includes a semantic meaning of deleting specific information from an original image, modifying specific information of the original image, or adding new content, an operation of deleting content from, modifying content of, or adding content to the original image is performed based on the semantic information in the text. The semantic meaning in the text is consistent with content of an edited image. The edited image herein is an image newly generated based on the semantic information in the text, or an image obtained after a modification operation, an addition operation, or a deletion operation is performed.

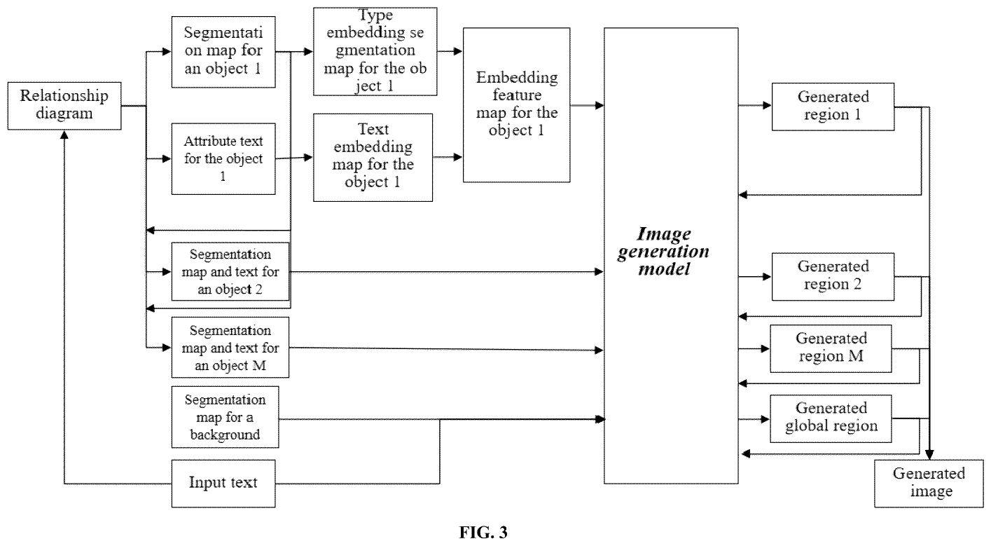

(1) When the image editing operation is the operation of generating a new image, as shown in FIG. 3, that the image editing operation is performed based on the semantic information in the text specifically includes the following steps:

S211: Determine entities and entity attributes in the text based on the semantic information in the text, and determine a relationship network between entities based on the entities and the entity attributes in the text, where the entities include target objects in an image and an image background. The entity attributes herein may be attributes about quantities, locations, sizes, or other attributes. The relationship network between entities corresponds to a relationship diagram shown in FIG. 3.

The text may be input into a ChatGPT model (or another language model or a relation extraction model) to extract a relationship between entities.

S212: Generate an entity mask map corresponding to each entity based on the relationship network between entities, where the entity mask map is used to define an image region in which the entity is placed.

An entity mask map corresponding to the image background is obtained by performing a reverse operation based on entity mask maps for target objects.

S213: Perform entity type embedding on the entity mask map for each entity to obtain each entity type embedding mask map.

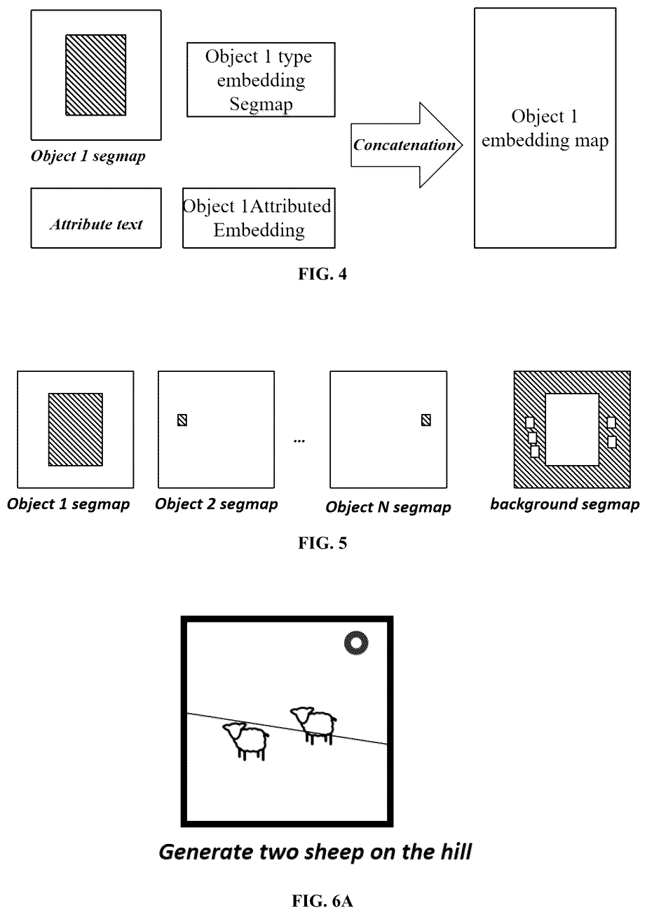

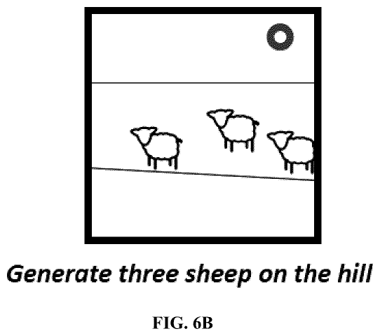

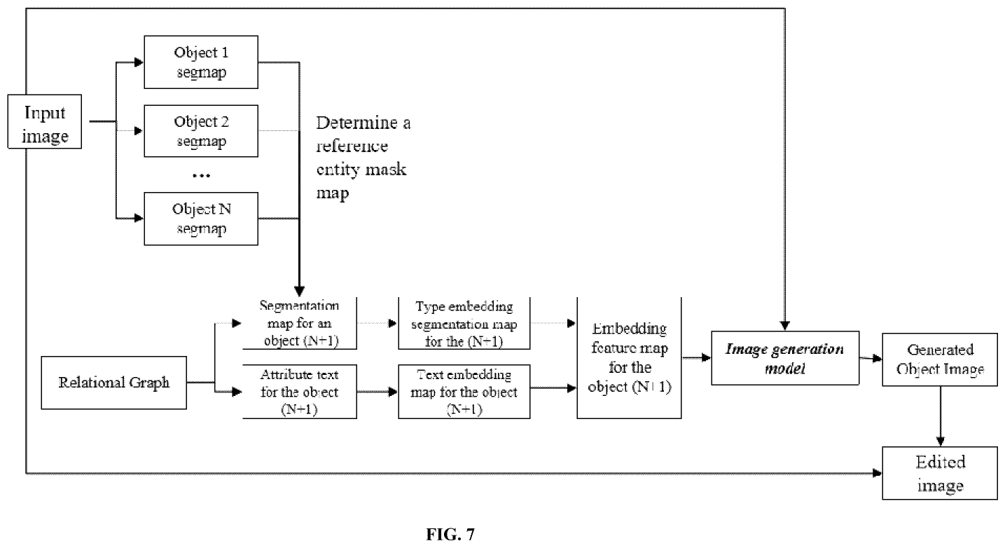

S214: Generate a text embedding map for each entity based on a textual description of an entity attribute in the text, and obtain each entity embedding feature map based on each entity type embedding mask map and a corresponding text embedding map, as shown in FIG. 4.

S215: Input each entity embedding feature map into an image generation model to obtain the edited image. FIG. 5 shows two generated images. ERNIE Bot can be used as the image generation model.

Each entity corresponds to each object in FIG. 3. Segmentation maps for objects 1 to M in FIG. 3 are entity mask maps for M entities. A type embedding segmentation map for the object 1 is a type embedding mask map for the object 1. A mask map is also referred to as a segmentation map.

In the following, an example is provided for a clearer understanding of a new image generation process. The semantic information in the text indicates “generation of three sheep on the hill”. In addition, the semantic information clarifies feature information of the hill, position relationships among the three sheep, and appearance information of the sheep. In this example, entities include the hill and the three sheep, and entity attributes include the feature information of the hill, and positions and appearance information of the sheep. The hill is used as the image background, and the three sheep are the target objects in the image. Entity identification is implemented by parsing the semantic information in the text and identifying entities and entity attributes in the text. In this way, relationships among the entities are extracted, and a relationship network between the entities is obtained.

Based on the relationship network between the entities, mask maps for all the entities are generated, such as a mask map corresponding to the hill and mask maps corresponding to the three sheep. The mask maps clearly reflect positions of the entities. In other words, the mask maps each reflects a region, such as a rectangular region. Then, type embedding is performed on the mask map corresponding to the hill and the mask maps corresponding to the three sheep. Herein, an entity type of the hill indicates the hill, and an entity type of the sheep indicate the sheep. After type embedding is performed, an image region in an entity mask map changes to a shape of a corresponding type of an entity. For example, a rectangular region in an entity mask map corresponding to the sheep changes to a sheep-shaped region. Finally, an entity type embedding mask map is obtained. Subsequently, entity attribute text is embedded. In other words, a latent space vector map (a text embedding map) is generated based on the entity attribute text. Then, a hill type embedding mask map corresponding to the hill are input into the image generation model, and a sheep type embedding mask map corresponding to each of the three sheep and a text embedding map corresponding to the sheep are input into the image generation model. In this way, a hill embedding feature map and a sheep embedding feature map corresponding to each of the three sheep are generated. Finally, an entity embedding feature map for each entity is input into the image generation model to generate an image consistent with the semantic information in the text.

For example, the editing operation is a generation operation, and the semantic information in the text indicates “a monkey with five bananas in hands”. The following information is concluded:
Object: monkey; quantity: 1; and attributes: [in hands, banana, and five]
Object: banana; quantity: 5; and attribute: [ ]

Entity mask maps for all entities are shown in FIG. 5.

Step S215 specifically includes the following steps:

(1) Randomly number the target objects.

(2) Input an entity embedding feature map corresponding to a first target object and a blank image into the image generation model to obtain an image including one target object.

(3) Input an image including first i target objects and an entity embedding feature map corresponding to an (i+1)^{th} target object into the image generation model to obtain an image including (i+1) target objects, where i=1, 2, 3, . . . , and M, and M represents a quantity of target objects. M target objects correspond to generated regions 1 to M in FIG. 3.

(4) Let i=i+1, and repeat the step (2) “input an image including first i target objects and an entity embedding feature map corresponding to an (i+1)^{th} target object into the image generation model”, until an image including M target objects is obtained.

(5) Input the image including M target objects and an entity embedding feature map corresponding to the image background into the image generation model to generate the edited image, where content in the edited image is consistent with the semantic information in the text. A generated global region in FIG. 3 corresponds to an image background region.

After Step S215 is performed, a quantity of target objects and a relative relationship between the target objects in the image can be controlled.

(2) When the image editing operation is the operation of adding content to a to-be-edited image, as shown in FIG. 7, that the image editing operation is performed based on the semantic information in the text specifically includes the following steps:

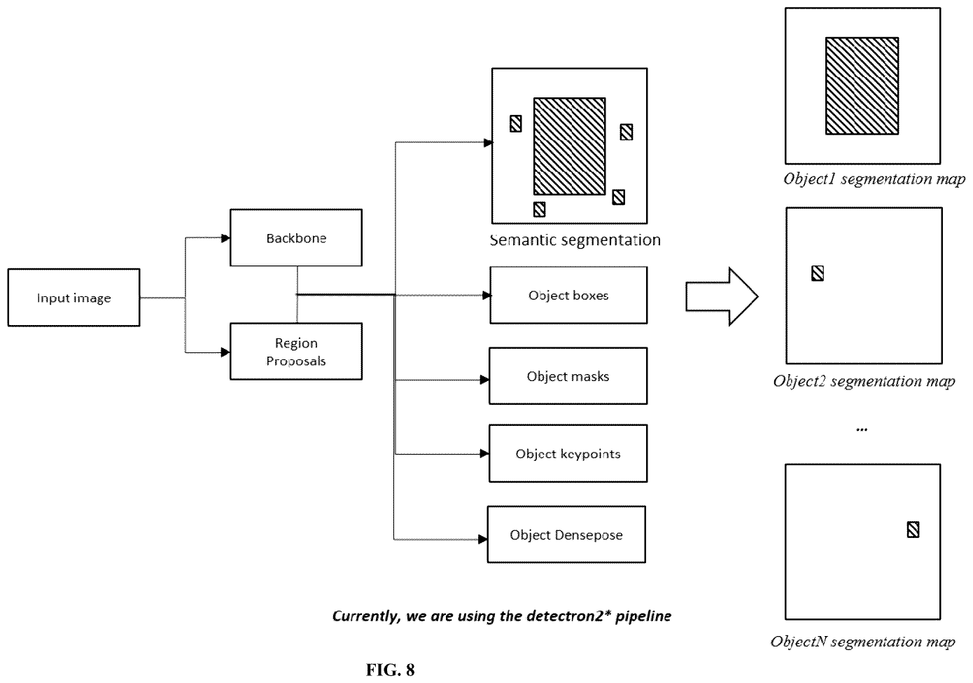

S221: Identify original entities and original entity attributes in the to-be-edited image, and generate original entity mask maps for all the original entities, as shown in FIG. 8. To-be-edited images correspond to input images in FIG. 7 and FIG. 8. Segmentation maps for objects 1 to N indicate original entity mask maps for all original entities in the input image.

S222: Select a reference entity mask map from the original entity mask maps based on the semantic information (which can be a network relationship between entities) in the text, where the reference entity mask map is a mask map corresponding to an original entity mentioned in the semantic information in the text.

For example, the text is: “generation of a garden on the left side of a house”. In this case, an entity mask map corresponding to the house in the to-be-edited image needs to be determined based on the semantic information in the text. Herein, a reference entity mask map is the entity mask map for the house.

S223: Determine a new entity mask map corresponding to a new entity based on the reference entity mask map.

In the new entity mask map, an image region corresponding to the new entity is on the left side of the house. The new entity mask map includes only the image region of the new entity.

S224: Perform entity type embedding on the new entity mask map to obtain a new entity type embedding mask map.

S225: Generate a text embedding map for the new entity based on a textual description of a new entity attribute in the text, and obtain an embedding feature map for the new entity based on the new entity type embedding mask map and the corresponding text embedding map.

S226: Input the to-be-edited image and the embedding feature map for the new entity into the image generation model to obtain a new entity image, where the new entity image incorporates image information of the to-be-edited image.

In this step, only the new entity image is generated. In order to ensure that the new entity image generated by the model and the image information of the to-be-edited image are more efficiently incorporated, the to-be-edited image also needs to be input into the image generation model, so that the model can learn an image environment of the to-be-edited image.

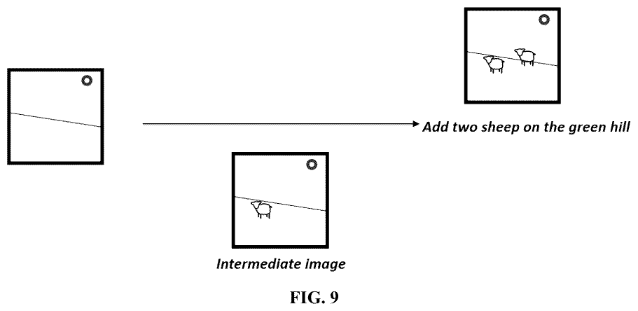

S227: Input the new entity image and the to-be-edited image into the image generation model to obtain the edited image. FIG. 9 shows an image that is obtained after two sheep are added to an input image, and a first image in FIG. 9 is the input image. The edited image is an image obtained after the new entity image is added to the to-be-edited image.

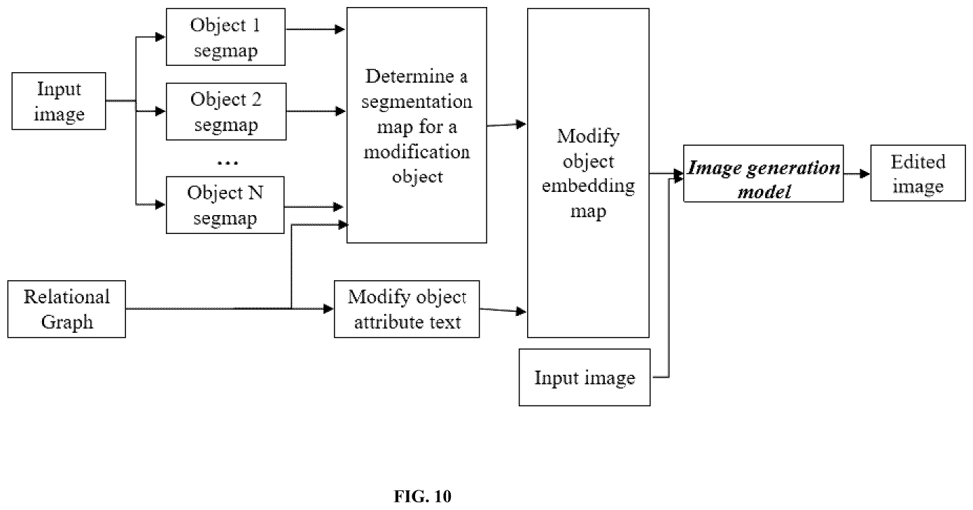

(3) When the image editing operation is the operation of modifying content of the to-be-edited image, as shown in FIG. 10, that the image editing operation is performed based on the semantic information in the text specifically includes the following steps:

S231: Identify original entities (which correspond to objects 1 to N in FIG. 10) and original entity attributes in the to-be-edited image (which is the input image), and generate original entity mask maps (which correspond to segmentation maps for the objects 1 to N in FIG. 10) for all the original entities.

S232: Select a to-be-modified entity mask map (which corresponds to a segmentation map for a modification object in FIG. 10) from the original entity mask maps based on the semantic information in the text, and modify the to-be-modified entity mask map to a modified entity mask map based on a textual description of a modified entity attribute in the text. The semantic information in the text records an original entity that is to be modified and provides an information description of a modified entity.

S233: Obtain an embedding feature map for the modified entity (which is an embedding feature map for the modification object in FIG. 10) based on the textual description of the modified entity attribute and the modified entity mask map.

Herein, a corresponding text embedding map is first generated based on the textual description of the modified entity attribute. Then, the text embedding map and the modified entity mask map are input into the image generation model to obtain the embedding feature map for the modified entity.

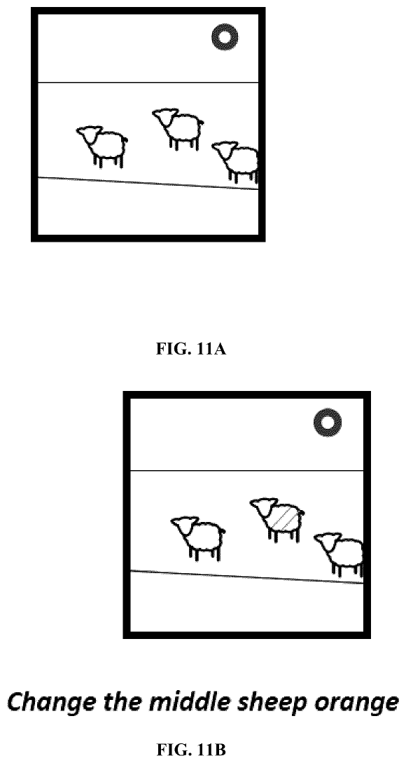

S234: Input the embedding feature map for the modified entity and the to-be-edited image into the image generation model to obtain the edited image. FIGS. 11A-11B show image result obtained after a middle sheep is modified based on an input image, and FIG. 11A is the input image. The edited image is an image generated after a modification operation is performed.

The to-be-edited image is input into the image generation model. Then, the model learns an environment of the to-be-edited image, and erases unnecessary information (information about a to-be-modified region) from the environment. The model modifies only image information of a region corresponding to a textual description of the to-be-edited image without modifying another part of information. Finally, the model generates related image information for the textual description based on the semantic information in the text.

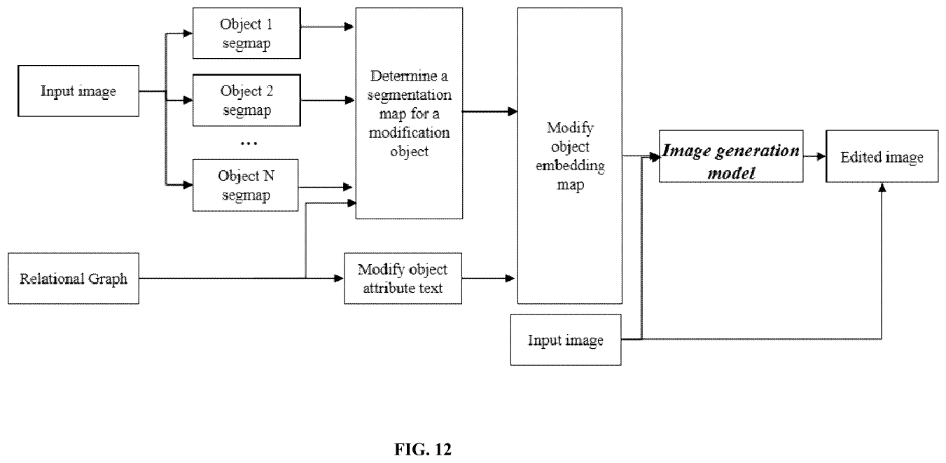

(4) When the image editing operation is the operation of deleting content from the to-be-edited image, as shown in FIG. 12, that the image editing operation is performed based on the semantic information in the text specifically includes the following steps:

S241: Identify original entities (which correspond to objects 1 to N in FIG. 12) and original entity attributes in the to-be-edited image, and generate original entity mask maps (which correspond to segmentation maps for the objects 1 to N in FIG. 12) for all the original entities.

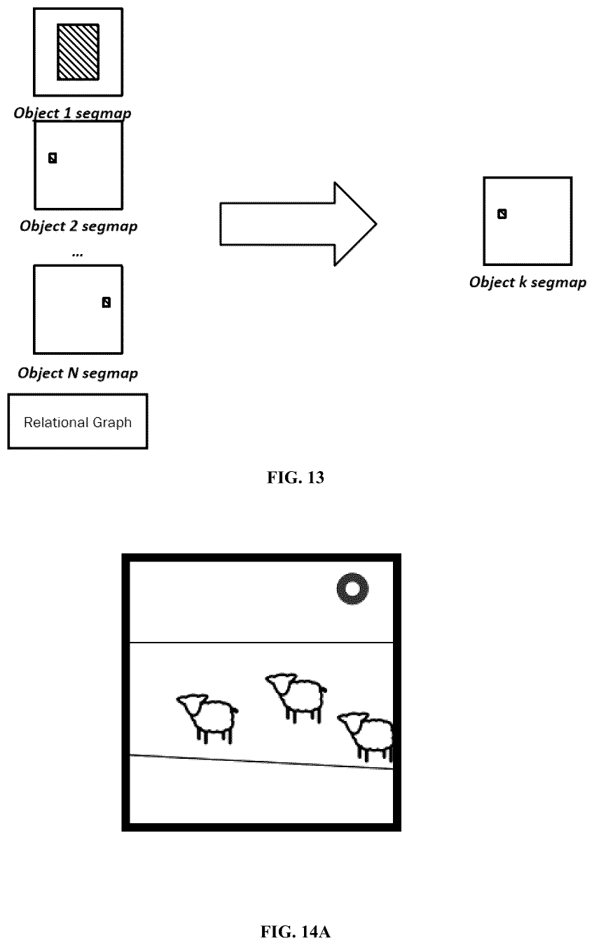

S242: Select a to-be-deleted entity mask map from the original entity mask maps based on the semantic information in the text, where the semantic information in the text records an original entity that is to be deleted. As shown in FIG. 13, a segmentation map for an object K is the to-be-deleted entity mask map.

The semantic information in the text is used to indicate an object to be deleted from the to-be-edited image.

S243: Combine all the original entity mask maps except the to-be-deleted entity mask map, and generate an embedding feature map for a combined entity based on a combined mask map.

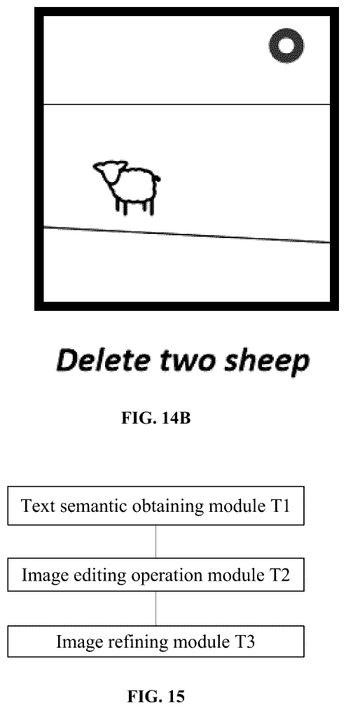

S244: Input the embedding feature map for the combined entity and the to-be-edited image into the image generation model to obtain the edited image. The edited image is an image obtained after a deletion operation is performed. FIGS. 14A-14B show image result obtained after two sheep are deleted from an input image, and FIG. 14A is the input image.

Herein, the to-be-edited image is input into the image generation model, so that the model learns image information of the to-be-edited image. This ensures image information coherence between a deleted region and another part in the image.

S3: Refine the edited image to obtain a refined image.

The edited image is input into an image optimization model to obtain the refined image, where the image optimization model uses a diffusion model as a backbone network. Refining processing helps improve image resolution and further ensures quality of the edited image.

### Embodiment 2

As shown in FIG. 15, this embodiment provides a semantic-based image editing system. The system includes a text semantic obtaining module T1, an image editing operation module T2, and an image refining module T3.

The text semantic obtaining module T1 is configured to: obtain text on which image editing is based and parse semantic information in the text, where the semantic information in the text is used to describe an image editing operation and image content corresponding to the operation.

The image editing operation module T2 is configured to perform the image editing operation based on the semantic information in the text. The image editing operation includes at least one of an operation of generating a new image, an operation of adding content to a to-be-edited image, an operation of modifying content of the to-be-edited image, and an operation of deleting content from the to-be-edited image.

The image refining module T3 is configured to refine an edited image to obtain a refined image.

### Embodiment 3

This embodiment of the present disclosure provides a computer-readable storage medium storing a computer program. When the computer program is executed by a processor, the semantic-based image editing method in Embodiment 1 is implemented.

In addition, an embodiment of the present disclosure provides an electronic device. The electronic device includes a memory and a processor, where the memory is configured to store a computer program. The processor runs the computer program to enable the electronic device to perform the semantic-based image editing method in Embodiment 1.

Alternatively, the foregoing electronic device may be a server.

The embodiments of the present disclosure may be provided as methods, systems, or computer program products. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a magnetic disk memory, a compact disc read-only memory (CD-ROM), an optical memory, and the like) that include computer-usable program code.

The present disclosure is described with reference to the flowcharts and/or block diagrams of the method, the device (system), and the computer program product according to the embodiments of the present disclosure. It should be understood that each flow and/or block in the flowchart and/or block diagram and a combination of the flow and/or block in the flowchart and/or block diagram can be implemented by computer program instructions. These computer program instructions may be provided for a processor of a general-purpose computer, a special-purpose computer, an embedded processor, or another programmable data processing device to produce a machine, so that instructions executed by the processor of the computer or another programmable data processing device produce an apparatus used for implementing a function specified in one or more flows of the flowchart and/or one or more blocks of the block diagram.

These computer program instructions may also be stored in a computer-readable memory that can guide a computer or another programmable data processing device to work in a specific manner, so that the instructions stored in the computer-readable memory produce an article of manufacture including an instruction device, and the instruction device implements the functions specified in one or more flows of the flowchart and/or one or more blocks in the block diagram.

These computer program instructions may also be loaded onto the computer or the another programmable data processing device, so that a series of operating steps are performed on the computer or the another programmable device to generate computer-implemented processing, and instructions executed on the computer or the another programmable device provide steps for implementing the functions specified in the one or more flows of the flowchart and/or one or more blocks in the block diagram.

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related contents, references can be made to the description of the method.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

What is claimed is:

1. A semantic-based image editing method, wherein the method comprises:
obtaining text on which image editing is based and parsing semantic information in the text, wherein the semantic information in the text is used to describe an image editing operation and image content corresponding to the operation;
performing the image editing operation based on the semantic information in the text, wherein the image editing operation comprises at least one of an operation of generating a new image, an operation of adding content to a to-be-edited image, an operation of modifying content of the to-be-edited image, and an operation of deleting content from the to-be-edited image; and
refining an edited image to obtain a refined image.

2. The method according to claim 1, wherein when the image editing operation is the operation of generating a new image, the performing the image editing operation based on the semantic information in the text specifically comprises:
determining entities and entity attributes in the text based on the semantic information in the text, and determining a relationship network between entities based on the entities and the entity attributes in the text, wherein the entities comprise target objects in an image and an image background;
generating an entity mask map corresponding to each entity based on the relationship network between entities, wherein the entity mask map is used to define an image region in which the entity is placed;
performing entity type embedding on the entity mask map for each entity to obtain each entity type embedding mask map;
generating a text embedding map for each entity based on a textual description of an entity attribute in the text, and obtaining each entity embedding feature map based on each entity type embedding mask map and a corresponding text embedding map; and
inputting each entity embedding feature map into an image generation model to obtain the edited image.

3. The method according to claim 2, wherein the inputting each entity embedding feature map into an image generation model to obtain the edited image specifically comprises:
randomly numbering the target objects;
inputting an entity embedding feature map corresponding to a first target object and a blank image into the image generation model to obtain an image comprising one target object;
inputting an image comprising first i target objects and an entity embedding feature map corresponding to an (i+1)^{th} target object into the image generation model to obtain an image comprising (i+1) target objects, wherein i=1, 2, 3, . . . , and M, and M represents a quantity of target objects;
letting i=i+1, and repeating the step “inputting an image comprising first i target objects and an entity embedding feature map corresponding to an (i+1)^{th} target object into the image generation model”, until an image comprising M target objects is obtained; and
inputting the image comprising M target objects and an entity embedding feature map corresponding to the image background into the image generation model to generate the edited image, wherein content in the edited image is consistent with the semantic information in the text.

4. The method according to claim 1, wherein when the image editing operation is the operation of adding content to a to-be-edited image, the performing the image editing operation based on the semantic information in the text specifically comprises:
identifying original entities and original entity attributes in the to-be-edited image, and generating original entity mask maps for all the original entities;
selecting a reference entity mask map from the original entity mask maps based on the semantic information in the text, wherein the reference entity mask map is a mask map corresponding to an original entity mentioned in the semantic information in the text;
determining a new entity mask map corresponding to a new entity based on the reference entity mask map;
performing entity type embedding on the new entity mask map to obtain a new entity type embedding mask map;
generating a text embedding map for the new entity based on a textual description of a new entity attribute in the text, and obtaining an embedding feature map for the new entity based on the new entity type embedding mask map and the corresponding text embedding map;
inputting the to-be-edited image and the embedding feature map for the new entity into an image generation model to obtain a new entity image, wherein the new entity image incorporates image information of the to-be-edited image; and
inputting the new entity image and the to-be-edited image into the image generation model to obtain the edited image, wherein the edited image is an image obtained after the new entity image is added to the to-be-edited image.

5. The method according to claim 1, wherein when the image editing operation is the operation of modifying content of the to-be-edited image, the performing the image editing operation based on the semantic information in the text specifically comprises:
identifying original entities and original entity attributes in the to-be-edited image, and generating original entity mask maps for all the original entities;
selecting a to-be-modified entity mask map from the original entity mask maps based on the semantic information in the text, and modifying the to-be-modified entity mask map to a modified entity mask map based on a textual description of a modified entity attribute in the text, wherein the semantic information in the text records an original entity that is to be modified and provides an information description of a modified entity;
obtaining an embedding feature map for the modified entity based on the textual description of the modified entity attribute and the modified entity mask map; and
inputting the embedding feature map for the modified entity and the to-be-edited image into an image generation model to obtain the edited image, wherein the edited image is an image generated after a modification operation is performed.

6. The method according to claim 1, wherein when the image editing operation is the operation of deleting content from the to-be-edited image, the performing the image editing operation based on the semantic information in the text specifically comprises:
identifying original entities and original entity attributes in the to-be-edited image, and generating original entity mask maps for all the original entities;
selecting a to-be-deleted entity mask map from the original entity mask maps based on the semantic information in the text, wherein the semantic information in the text records an original entity that is to be deleted;
combining all the original entity mask maps except the to-be-deleted entity mask map, and generating an embedding feature map for a combined entity based on a combined mask map; and
inputting the embedding feature map for the combined entity and the to-be-edited image into an image generation model to obtain the edited image, wherein the edited image is an image obtained after a deletion operation is performed.

7. The method according to claim 1, wherein the obtaining text on which image editing is based and parsing semantic information in the text specifically comprises:
obtaining the text on which image editing is based and parsing the text by using a natural language processing (NLP) technology, to obtain the semantic information in the text.

8. The method according to claim 1, wherein the refining an edited image to obtain a refined image specifically comprises:
inputting the edited image into an image optimization model to obtain the refined image, wherein the image optimization model uses a diffusion model as a backbone network.

9. A semantic-based image editing system, wherein the system comprises:
a text semantic obtaining module, configured to: obtain text on which image editing is based and parse semantic information in the text, wherein the semantic information in the text is used to describe an image editing operation and image content corresponding to the operation;
an image editing operation module, configured to perform the image editing operation based on the semantic information in the text, wherein the image editing operation comprises at least one of an operation of generating a new image, an operation of adding content to a to-be-edited image, an operation of modifying content of the to-be-edited image, and an operation of deleting content from the to-be-edited image; and
an image refining module, configured to refine an edited image to obtain a refined image.

10. A computer-readable storage medium storing a computer program, wherein when the computer program is executed by a processor, the semantic-based image editing method according to claim 1 is implemented.

11. The computer-readable storage medium according to claim 10, wherein when the image editing operation is the operation of generating a new image, the performing the image editing operation based on the semantic information in the text specifically comprises:
determining entities and entity attributes in the text based on the semantic information in the text, and determining a relationship network between entities based on the entities and the entity attributes in the text, wherein the entities comprise target objects in an image and an image background;
generating an entity mask map corresponding to each entity based on the relationship network between entities, wherein the entity mask map is used to define an image region in which the entity is placed;
performing entity type embedding on the entity mask map for each entity to obtain each entity type embedding mask map;
generating a text embedding map for each entity based on a textual description of an entity attribute in the text, and obtaining each entity embedding feature map based on each entity type embedding mask map and a corresponding text embedding map; and
inputting each entity embedding feature map into an image generation model to obtain the edited image.

12. The computer-readable storage medium according to claim 11, wherein the inputting each entity embedding feature map into an image generation model to obtain the edited image specifically comprises:
randomly numbering the target objects;
inputting an entity embedding feature map corresponding to a first target object and a blank image into the image generation model to obtain an image comprising one target object;
inputting an image comprising first i target objects and an entity embedding feature map corresponding to an (i+1)^{th} target object into the image generation model to obtain an image comprising (i+1) target objects, wherein i=1, 2, 3, . . . , and M, and M represents a quantity of target objects;
letting i=i+1, and repeating the step “inputting an image comprising first i target objects and an entity embedding feature map corresponding to an (i+1)^{th} target object into the image generation model”, until an image comprising M target objects is obtained; and
inputting the image comprising M target objects and an entity embedding feature map corresponding to the image background into the image generation model to generate the edited image, wherein content in the edited image is consistent with the semantic information in the text.

13. The computer-readable storage medium according to claim 10, wherein when the image editing operation is the operation of adding content to a to-be-edited image, the performing the image editing operation based on the semantic information in the text specifically comprises:
identifying original entities and original entity attributes in the to-be-edited image, and generating original entity mask maps for all the original entities;
selecting a reference entity mask map from the original entity mask maps based on the semantic information in the text, wherein the reference entity mask map is a mask map corresponding to an original entity mentioned in the semantic information in the text;
determining a new entity mask map corresponding to a new entity based on the reference entity mask map;
performing entity type embedding on the new entity mask map to obtain a new entity type embedding mask map;
generating a text embedding map for the new entity based on a textual description of a new entity attribute in the text, and obtaining an embedding feature map for the new entity based on the new entity type embedding mask map and the corresponding text embedding map;
inputting the to-be-edited image and the embedding feature map for the new entity into an image generation model to obtain a new entity image, wherein the new entity image incorporates image information of the to-be-edited image; and
inputting the new entity image and the to-be-edited image into the image generation model to obtain the edited image, wherein the edited image is an image obtained after the new entity image is added to the to-be-edited image.

14. The computer-readable storage medium according to claim 10, wherein when the image editing operation is the operation of modifying content of the to-be-edited image, the performing the image editing operation based on the semantic information in the text specifically comprises:
identifying original entities and original entity attributes in the to-be-edited image, and generating original entity mask maps for all the original entities;
selecting a to-be-modified entity mask map from the original entity mask maps based on the semantic information in the text, and modifying the to-be-modified entity mask map to a modified entity mask map based on a textual description of a modified entity attribute in the text, wherein the semantic information in the text records an original entity that is to be modified and provides an information description of a modified entity;
obtaining an embedding feature map for the modified entity based on the textual description of the modified entity attribute and the modified entity mask map; and
inputting the embedding feature map for the modified entity and the to-be-edited image into an image generation model to obtain the edited image, wherein the edited image is an image generated after a modification operation is performed.

15. The computer-readable storage medium according to claim 10, wherein when the image editing operation is the operation of deleting content from the to-be-edited image, the performing the image editing operation based on the semantic information in the text specifically comprises:
identifying original entities and original entity attributes in the to-be-edited image, and generating original entity mask maps for all the original entities;
selecting a to-be-deleted entity mask map from the original entity mask maps based on the semantic information in the text, wherein the semantic information in the text records an original entity that is to be deleted;
combining all the original entity mask maps except the to-be-deleted entity mask map, and generating an embedding feature map for a combined entity based on a combined mask map; and
inputting the embedding feature map for the combined entity and the to-be-edited image into an image generation model to obtain the edited image, wherein the edited image is an image obtained after a deletion operation is performed.

16. The computer-readable storage medium according to claim 10, wherein the obtaining text on which image editing is based and parsing semantic information in the text specifically comprises:
obtaining the text on which image editing is based and parsing the text by using a natural language processing (NLP) technology, to obtain the semantic information in the text.

17. The computer-readable storage medium according to claim 10, wherein the refining an edited image to obtain a refined image specifically comprises:
inputting the edited image into an image optimization model to obtain the refined image, wherein the image optimization model uses a diffusion model as a backbone network.
